(19) United States
(12) Patent Application Publication
(10) Pub. No.: US 2025/0319431 A1
(43) Pub. Date: Oct. 16, 2025

(54) HYDROGEN-PERMEABLE FILTER

(71) Applicant: Panasonic Intellectual Property Management Co., Ltd., Osaka (JP)

(72) Inventors: Yui NAKAI, Osaka (JP); Akitoshi KASAHARA, Osaka (JP); Kenshi TSUJI, Osaka (JP); Tetsuya NAKAAZE, Osaka (JP)

(73) Assignee: Panasonic Intellectual Property Management Co., Ltd., Osaka (JP)

(21) Appl. No.: 18/866,116

(22) PCT Filed: May 17, 2023
(86) PCT No.: PCT/JP2023/018416

§ 371 Date: Nov. 15, 2024

(30) Foreign Application Priority Data
May 27, 2022 (JP) 2022-086942

(51) Int. Cl. B01D 39/12; H01M 8/0662

(52) U.S. Cl. CPC B01D 39/12; H01M 8/0687; B01D 2239/1291

(57) ABSTRACT

A hydrogen-permeable filter includes a tungsten mesh including a plurality of tungsten wires that are woven. For example, the plurality of tungsten wires each have an elongation percentage greater than or equal to 5%. For example, the plurality of tungsten wires each have a tensile strength greater than or equal to 1600 MPa. For example, the plurality of tungsten wires each have a diameter less than or equal to 40 μm.

### TECHNICAL FIELD

The present invention relates to a hydrogen-permeable filter.

### BACKGROUND ART

Patent Literature (PTL) 1 discloses, as a hydrogen-permeable filter for a fuel cell, a tubular filter manufactured using stainless steel.

### CITATION LIST

### Patent Literature

[PTL 1] Japanese Unexamined Patent Application Publication No. 2016-221523

### SUMMARY OF INVENTION

### Technical Problem

However, in the above-described conventional tubular filter, there is the problem that embrittlement occurs easily.

In view of this, the present invention has as an object to provide a hydrogen-permeable filter in which embrittlement does not occur easily.

### Solution to Problem

A hydrogen-permeable filter according to an aspect of the present invention includes: a tungsten mesh including a plurality of tungsten wires that are woven.

### Advantageous Effects of Invention

The present invention can provide a hydrogen-permeable filter in which embrittlement does not occur easily.

### BRIEF DESCRIPTION OF DRAWINGS

FIG. 1 is a schematic diagram illustrating the external appearance of a hydrogen-permeable filter and a part thereof under magnification.

FIG. 2 is a flowchart illustrating a method of manufacturing a tungsten wire included in the hydrogen-permeable filter.

FIG. 3 is a scatter graph illustrating the relationship between elongation percentage and tensile strength of tungsten wires according to working examples and a comparative example.

FIG. 4 is a graph illustrating the result of a tensile test on a tungsten wire after hydrogen charging.

FIG. 5 is a graph illustrating change in tensile strength due to hydrogen charging.

FIG. 6 is a diagram illustrating an outline of a coiling test on a tungsten wire according to an embodiment.

FIG. 7 is a cross-sectional view illustrating a metal mesh that is woven using tungsten wires 10 according to the present embodiment.

FIG. 8A is a diagram illustrating an external appearance of a tungsten wire according to Working Example 16 subjected to the coiling test.

FIG. 8B is a diagram illustrating a part of FIG. 8A under magnification.

FIG. 9A is a diagram illustrating an external appearance of a tungsten wire according to Comparative Example 10 subjected to the coiling test.

FIG. 9B is a diagram illustrating a part of FIG. 9A under magnification.

### DESCRIPTION OF EMBODIMENTS

Hereinafter, a hydrogen-permeable filter according to embodiments of the present invention will be described in detail with reference to the Drawings. It should be noted that each of the embodiments described shows a specific example of the present invention. Therefore, numerical values, shapes, materials, elements, the arrangement and connection of the elements, steps, the processing order of the steps, etc., indicated in the following embodiments are mere examples, and thus are not intended to limit the present invention. Accordingly, among the elements described in the following embodiments, elements not recited in any independent claim are described as optional elements.

Furthermore, the figures are schematic illustrations and are not necessarily accurate depictions. Therefore, for example, the scaling, etc., in the figures is not necessarily uniform. Elements which are substantially the same have the same reference signs in the figures, and duplicate description may be omitted or simplified.

In the Written Description, terms indicating relationships between elements, terms indicating shapes of elements such as cylindrical, and numerical ranges are expressions that refer not only to their strict meanings, but encompass a range of essentially equivalents, such as a range of deviations of a few percent.

### EMBODIMENT

### [Configuration]

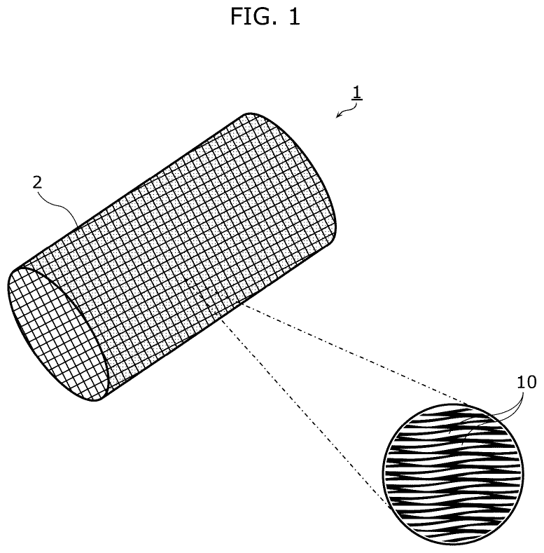

First, an outline of hydrogen-permeable filter 1 according to the present embodiment will be described with reference to FIG. 1. FIG. 1 is a schematic diagram illustrating the external appearance of hydrogen-permeable filter 1 according to the present embodiment and a part thereof under magnification.

Hydrogen-permeable filter 1 is a filter that allows hydrogen to pass through and removes foreign objects. Hydrogen-permeable filter 1 is used in, for example, a fuel cell. For example, hydrogen-permeable filter 1 is used within a range in which hydrogen pressure is less than or equal to 135 MPa. It should be noted that 135 MPa is a pressure that is an upper limit of hydrogen pressure up to which an SSRT test described later can be conducted.

Hydrogen-permeable filter 1 may be used within a range in which hydrogen pressure is less than or equal to 110 MPa. Accordingly, hydrogen-permeable filter 1 can be used in a typical hydrogen station or the like. Furthermore, hydrogen-permeable filter 1 may be used within a range in which hydrogen pressure is less than or equal to 70 MPa. Accordingly, hydrogen-permeable filter 1 can be used in an automobile equipped with a fuel cell, an automobile equipped with a hydrogen fuel engine, or the like.

As illustrated in FIG. 1, hydrogen-permeable filter 1 includes tungsten mesh 2 woven using a plurality of tungsten wires 10. Specifically, hydrogen-permeable filter 1 includes one or more tungsten meshes 2 each having a cylindrical shape. For example, hydrogen-permeable filter 1 includes two layered tungsten meshes 2 each having a cylindrical shape. When a plurality of tungsten meshes 2 are layered, filtering performance can be maintained even when one of the plurality of tungsten meshes 2 is torn.

It should be noted that the shapes of tungsten meshes 2 may each be rectangular-tube, truncated-cone, or truncated-pyramid shape, or may each be a shape with a bottom. In this case, the bottom may be planar, concave, or convex. Furthermore, one or more tungsten meshes 2 need not have a three-dimensional shape and may have a planar shape.

Tungsten mesh 2 includes a plurality of tungsten wires 10 as warp yarn and weft yarn. A weave pattern of tungsten mesh 2 is Dutch weave. Dutch weave is, for example, twilled Dutch weave or plain Dutch weave. Tungsten mesh 2 is manufactured by Dutch weaving the plurality of tungsten wires 10 used as warp yarn and weft yarn.

Dutch weave is a weave pattern that can have small openings of its mesh. For this reason, hydrogen-permeable filter 1 including tungsten mesh 2 of Dutch weave has high filtering performance. Furthermore, tungsten wire 10 is not easily embrittled (which will be described later in detail), and thus it is possible to provide hydrogen-permeable filter 1 that is excellent in durability.

### [Tungsten Wire]

Next, a configuration of tungsten wire 10 will be described.

Tungsten wire 10 is an alloy wire including an alloy of tungsten (W) and at least one type of metallic element other than tungsten (hereinafter, referred to as an alloying element). A content of tungsten contained in tungsten wire 10 is, for example, greater than or equal to 90 wt %. Here, the content is a proportion of a mass of the metallic element (e.g., tungsten) with respect to a mass of tungsten wire 10. The content of tungsten may be greater than or equal to 95 wt %, may be greater than or equal to 99 wt %, or may be greater than or equal to 99.9 wt %.

The at least one type of alloying element is a metallic element included in Group 7 or Group 8 in the periodic table. Specifically, the alloying element is rhenium (Re) in Group 7 or ruthenium (Ru) in Group 8. For example, tungsten wire 10 is an alloy wire including tungsten and rhenium (hereinafter, referred to as a rhenium-tungsten alloy wire). Alternatively, tungsten wire 10 is an alloy wire including tungsten and ruthenium (hereinafter, referred to as a ruthenium-tungsten alloy wire). It should be noted that tungsten wire 10 may be an alloy wire including tungsten and two or more types of alloying elements, such as an alloy wire including tungsten, rhenium, and ruthenium.

In the case of the rhenium-tungsten alloy wire, a content of rhenium is, for example, greater than or equal to 0.1 wt % and less than or equal to 10 wt %. The content of rhenium may be greater than or equal to 0.5 wt % and less than or equal to 9 wt % or may be greater than or equal to 3 wt % and less than or equal to 5 wt %. In the case of the ruthenium-tungsten alloy wire, a content of ruthenium is, for example, greater than or equal to 0.05 wt % and less than or equal to 0.3 wt %. The content of ruthenium may be greater than or equal to 0.1 wt % and less than or equal to 0.2 wt %.

The greater the content of rhenium and/or ruthenium, the higher the elongation percentage and tensile strength of tungsten wire 10. However, a high tensile strength causes such a problem that the elongation percentage is unlikely to increase. Furthermore, the greater the content of rhenium and/or ruthenium, the more difficult it is to reduce a diameter of tungsten wire 10. In the present embodiment, a content of the alloying element and a processing step of reducing the diameter are engineered through diligent studies by the inventors of the present application, thereby providing tungsten wire 10 that is thin, has a high elongation percentage, and has a high tensile strength. A specific method of manufacturing tungsten wire 10 will be described later.

The diameter of tungsten wire 10 is less than or equal to 40 μm. The diameter of tungsten wire 10 may be less than or equal to 30 μm or may be less than or equal to 20 μm. For example, the diameter of tungsten wire 10 may be less than or equal to 18 μm, may be less than or equal to 15 μm, may be less than or equal to 12 μm, or may be less than or equal to 10 μm. The diameter of tungsten wire 10 may be as small as a processing limit (e.g., 5 μm).

The elongation percentage of tungsten wire 10 according to the present embodiment is greater than or equal to 5%. Accordingly, when tungsten wires 10 are used as warp yarn and weft yarn of tungsten mesh 2, fracturing of tungsten wires 10 during weaving processing and during use of tungsten mesh 2 is suppressed. The elongation percentage of tungsten wire 10 may be greater than or equal to 7%, may be greater than or equal to 9%, may be greater than or equal to 11%, may be greater than or equal to 13%, or may be greater than or equal to 16%. The higher the elongation percentage, the more the effect of suppressing fracturing of tungsten wire 10 is enhanced.

Furthermore, tungsten wires 10 having an elongation percentage increased to greater than or equal to 5% can be used in Dutch weave. Dutch weave using tungsten wires 10 having an elongation percentage of 3% failed because of breaking during weaving processing. It should be noted that even tungsten wires 10 having an elongation percentage less than 5% can be used in a weave pattern such as plain weave to manufacture tungsten mesh 2.

It should be noted that the elongation percentage is equivalent to a percentage total extension at fracture and is measured with an extensometer. Specifically, a total elongation of tungsten wire 10 is a percentage total extension at fracture of tungsten wire 10. The total elongation is a total of an elastic elongation and a plastic elongation measured by the extensometer and is a value of the total with respect to an extensometer gauge length in terms of a percentage. In short, the elongation percentage refers to a proportion of a difference between a length after elongation and a length before elongation with respect to the length before elongation. An elongation percentage of a positive value means that a thread has elongated, and an elongation percentage of a negative value means that a thread has shortened.

The tensile strength of tungsten wire 10 is greater than or equal to 1600 MPa (=N/mm²) and less than or equal to 2400 MPa. Accordingly, when tungsten wires 10 are used as warp yarn and weft yarn of tungsten mesh 2, fracturing of tungsten wires 10 during manufacturing and during use of tungsten mesh 2 is suppressed. The tensile strength of tungsten wire 10 may be greater than or equal to 1700 MPa, may be greater than or equal to 1800 MPa, may be greater than or equal to 2000 MPa, or may be greater than or equal to 2100 MPa. The higher the tensile strength, the more the effect of suppressing the fracturing of tungsten wire 10 is enhanced. Furthermore, a durability of tungsten mesh 2 manufactured from tungsten wires 10 having a high tensile strength can be enhanced.

Tungsten wire 10 according to the present embodiment has both an elongation percentage greater than or equal to 5% and a tensile strength greater than or equal to 1600 MPa. However, this is not limitative of the elongation percentage and the tensile strength. For example, the tensile strength of tungsten wire 10 may be greater than or equal to 2400 MPa or may be greater than or equal to 4800 MPa. In this case, the elongation percentage of tungsten wire 10 may be less than 5%. Furthermore, the diameter of tungsten wire 10 may be greater than 40 μm.

### Manufacturing Method

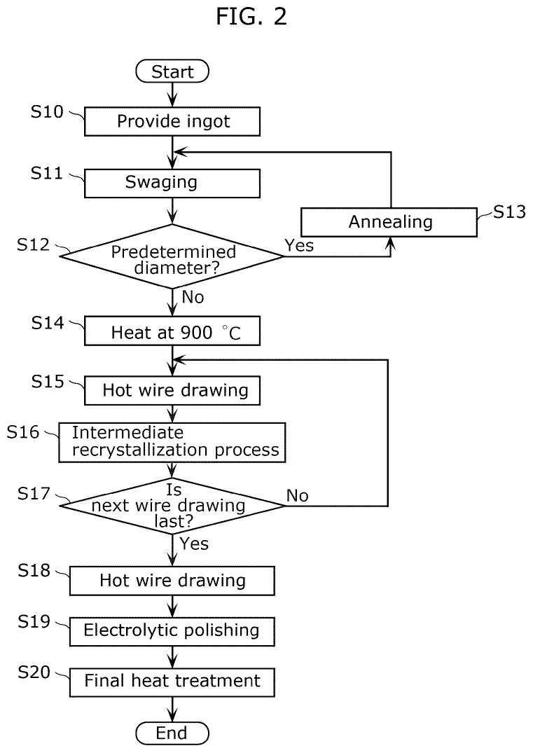

Subsequently, with reference to FIG. 2, a manufacturing method of tungsten wire 10 according to the present embodiment will be described. FIG. 2 is a flowchart illustrating an example of the manufacturing method of tungsten wire 10 according to the present embodiment.

As illustrated in FIG. 2, an ingot of a metal is first prepared (S10). Specifically, first, a mixture is prepared by mixing tungsten powder and powder including an alloying metal (for example, rhenium powder or ruthenium powder) in a predetermined ratio. An average particle diameter of the powder is within a range of greater than or equal to 3 μm and less than or equal to 4 μm. However, the average particle diameter is not limited to this. Pressing and sintering are performed on the prepared mixture to produce an ingot of the tungsten alloy. The ingot is, for example, a rod-shaped ingot having a cross section with a diameter of about 15 mm.

Next, a swaging process is performed on the ingot (S11). Specifically, the ingot is forged and compressed from around to be extended, thus being formed into a wire-shaped tungsten wire. A rolling process may be performed instead of the swaging process. The swaging process (S11) is repeatedly performed together with annealing (S13).

Specifically, as the swaging process is repeated, a diameter of the ingot is decreased in order of 13.6 mm, 10.6 mm, 8 mm, 6.5 mm, and 3.3 mm. When the diameter of the ingot is equal to each of these diameters (Yes in S12), the annealing is performed (S13). A temperature of the annealing is, for example, 2400° C. After the diameter is decreased to 3.3 mm, the ingot is subjected to the annealing and the swaging process, and thus the diameter becomes 3 mm.

Next, the tungsten wire subjected to the swaging process to have a diameter of 3 mm is heated at 900° C. (S14). Specifically, the tungsten wire is heated directly with a burner or the like. Heating the tungsten wire forms an oxide layer on a surface of the tungsten wire so that the tungsten wire does not break during processing in hot wire drawing that is subsequently performed.

Next, the hot wire drawing is performed (S15). Specifically, drawing of the tungsten wire, that is, wire drawing (reducing the diameter) of the tungsten wire is performed with one or more wire drawing dies while the tungsten wire is heated. A temperature of the heating is, for example, 1000° C. Note that the higher the temperature of the heating, the more the workability of the tungsten wire increases, and the wire drawing can be performed easily. The hot wire drawing is repeated while replacing one of the wire drawing dies with another. The reduction in area of the tungsten wire made by performing the wire drawing once with one wire drawing die is, for example, greater than or equal to 10% and less than or equal to 40%. In a step of the hot wire drawing, a lubricant including graphite dispersed in water may be used.

Next, an intermediate recrystallization process is performed on the tungsten wire subjected to the wire drawing (S16). Specifically, the tungsten wire is heated at a temperature greater than or equal to 1200° C. to recrystallize crystals included in the tungsten wire. Until the last time of a step of the wire drawing (No in S17), the hot wire drawing and the intermediate recrystallization process are repeated. The number of repetitions at this time (that is, the number of intermediate recrystallization processes) is, for example, greater than or equal to five and less than or equal to ten.

In the repetition of the hot wire drawing, a wire drawing die used in a certain wire drawing has a smaller bore diameter than a wire drawing die used in an immediately previous wire drawing. Furthermore, in the repetition of the hot wire drawing, the tungsten wire is heated at a temperature of the heating lower than a temperature of the heating in an immediately previous wire drawing. For example, a temperature of the heating in a wire drawing process immediately previous to a last wire drawing step is lower than temperatures of the heating in preceding wire drawing steps, for example, 400° C.

When the step of the wire drawing is the last time of the wire drawing (Yes in S17), the hot wire drawing is performed as the last wire drawing (S18). Accordingly, the tungsten wire having a diameter of less than about 40 μm is provided.

Next, electrolytic polishing is performed on the tungsten wire subjected to the wire drawing (S19). For example, the electrolytic polishing is driven by a potential difference made between a tungsten wire and a counter electrode that are immersed in an electrolyte solution such as aqueous sodium hydroxide. The electrolytic polishing enables fine adjustment of the diameter of the tungsten wire.

After the electrolytic polishing, final heat treatment is performed on the tungsten wire (S20). A temperature of the final heat treatment is, for example, greater than or equal to 1200° C. and less than or equal to 1700° C.

Through the above steps, tungsten wire 10 according to the present embodiment is manufactured. Immediately after being manufactured through the above manufacturing steps, tungsten wire 10 has a length of, for example, greater than or equal to 50 km, which enables industrial use of tungsten wire 10. Tungsten wire 10 is cut to an appropriate length in accordance with its usage and is used for the weaving of tungsten mesh 2 and the like. As described above, the present embodiment enables tungsten wire 10 to be industrially mass-produced and to be used in hydrogen-permeable filter 1.

It should be noted that the steps shown in the manufacturing method of tungsten wire 10 are performed in-line, for example. Specifically, a plurality of wire drawing dies used in step S15 and the like are disposed in a production line in descending order of bore diameter. In addition, a heating device such as a burner is disposed between every adjacent wire drawing dies. The heating device is disposed for the hot wire drawing and the intermediate recrystallization process. Furthermore, on a downstream side (post-processing side) of wire drawing dies used in step S15, a plurality of wire drawing dies used in step S18 are disposed in descending order of bore diameter, and on a downstream side of a wire drawing die having a smallest bore diameter, an electrolytic polishing device and a heating device for the final heat treatment are disposed. It should be noted that the steps may be performed individually.

### WORKING EXAMPLES

Subsequently, working examples of tungsten wire 10 manufactured according to the manufacturing method described above and comparative examples will be described. Tungsten wires 10 according to Working Examples 1 to 15 and Comparative Examples 1 to 8 shown below were manufactured to differ in various parameters in the manufacturing method (specifically, diameter, additive type, amount added, final heat treatment temperature, and the number of intermediate recrystallization processes) as appropriate. Specifically, the parameters are as shown in Table 1 and Table 2 below.

TABLE 1

| Working | | | Elongation | Tensile | Amount | Final heat | Number of intermediate |
|---|---|---|---|---|---|---|---|
| Example | Diameter | | percentage | strength | added | treatment | recrystallization |
| No. | [μm] | Additive | [%] | [MPa] | [wt %] | temperature [° C.] | processes [times] |
| 1 | 11 | Re | 6.9 | 1810 | 5 | 1400 | 8 |
| 2 | | | 7.5 | 1760 | | 1500 | |
| 3 | 12 | | 5.5 | 1740 | 3 | 1550 | 10 |
| 4 | 18 | | 11.8 | 1790 | 5 | 1600 | 7 |
| 5 | 35 | | 7.9 | 1920 | 3 | | 6 |
| 6 | | | 11.7 | 1810 | | 1700 | |
| 7 | | | 5.0 | 2120 | 5 | 1300 | |
| 8 | | | 7.1 | 2030 | | 1400 | |
| 9 | | | 13.8 | 1790 | | 1600 | |
| 10 | | | 5.1 | 1960 | 3 | 1700 | 5 |
| 11 | | Ru | 5.6 | 2200 | 0.2 | 1200 | 6 |
| 12 | | Re | 11.3 | 1930 | 5 | 1500 | 5 |
| 13 | | | 16.0 | 1740 | | 1600 | |
| 14 | | | 6.0 | 2110 | 9 | | 7 |
| 15 | | | 11.9 | 2050 | | 1700 | |

TABLE 2

| Comparative | | | Elongation | Tensile | Amount | Final heat | Number of intermediate |
|---|---|---|---|---|---|---|---|
| Example | Diameter | | percentage | strength | added | treatment | recrystallization |
| No. | [μm] | Additive | [%] | [MPa] | [wt %] | temperature [° C.] | processes [times] |
| 1 | 35 | Re | 2.0 | 2400 | 5 | 1200 | 5 |
| 2 | | | 2.5 | 2190 | | 1400 | |
| 3 | | | 1.4 | 2010 | 3 | 1600 | 3 |
| 4 | | | 0.9 | 1620 | | 1700 | |
| 5 | | | 1.2 | 1850 | 5 | | |
| 6 | 18 | | 1.2 | 2030 | | 1500 | 4 |
| 7 | | | 1.6 | 1840 | | 1550 | |
| 8 | 12 | | 1.1 | 2160 | | 1500 | 5 |

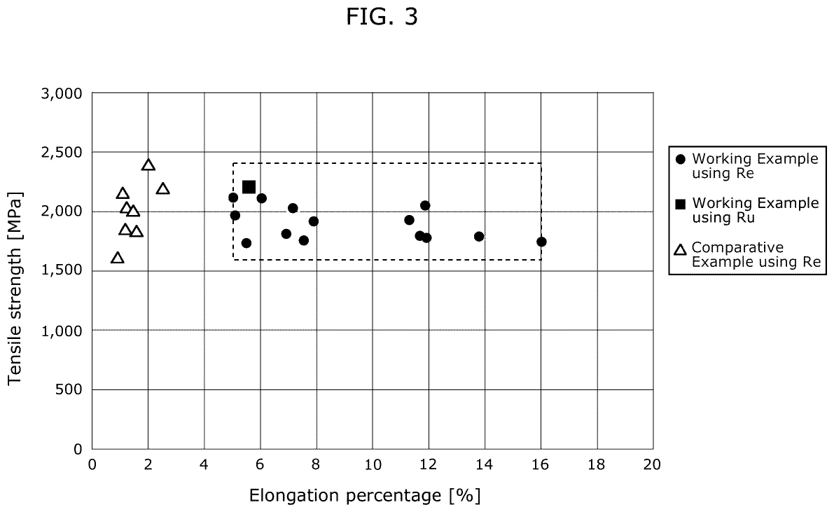

FIG. 3 is a scatter diagram illustrating a relationship between elongation percentages and tensile strengths of tungsten wires 10 according to working examples and comparative examples. In FIG. 3, the horizontal axis represents elongation percentage (unit: %) of tungsten wire 10 and the vertical axis represents tensile strength (unit: MPa) of tungsten wire 10.

Tungsten wires 10 according to Working Examples 1 to 15 all had diameters less than 40 μm. Furthermore, as shown in FIG. 3, tungsten wires 10 according to working examples all had tensile strengths that were greater than or equal to 1600 MPa and less than or equal to 2400 MPa and all had elongation percentages that fell within a range of greater than or equal to 5% and less than or equal to 16%. It should be noted that, in FIG. 3, the ranges of the tensile strengths and the elongation percentages described above are drawn with broken lines. In contrast, tungsten wires 10 according to Comparative Examples 1 to 8 are located out of the ranges drawn with the broken lines in FIG. 3.

Results of studies about the parameters in the manufacturing method of tungsten wire 10 that are assumed as factors of differences between working examples and comparative examples will be described below.

### <Additive>

First, types and amounts added (contents in tungsten wires 10) of alloying elements, which are additives, will be described. Table 1 shows that the elongation percentage tends to increase with an increase in the amount added of the alloying element.

Furthermore, in Table 1, Working Example 5 and Working Example 9 were the same in the parameters except for an amount added of Re: diameter (35 μm), additive (Re), final heat treatment temperature (1600° C.), and the number of intermediate recrystallization processes (6 times). Comparison between Working Example 5 and Working Example 9 shows that Working Example 9 with a larger amount added of Re had a higher elongation percentage and a lower tensile strength compared with Working Example 5.

From this, increasing the amount added of the alloying element can lead to a higher elongation percentage while keeping the tensile strength greater than or equal to 1600 MPa. Conversely, reducing the amount added of the alloying element can lead to a higher tensile strength while keeping the elongation percentage greater than or equal to 5%.

It should be noted that using Ru as the additive, as in Working Example 11, can keep both a high elongation percentage and a high tensile strength even when an amount added of Ru is approximately one order of magnitude smaller than an amount added of Re.

### <Final Heat Treatment Temperature>

Next, the final heat treatment temperature will be described. Table 1 shows that the elongation percentage tends to increase with an increase in the final heat treatment temperature.

Furthermore, in Table 1, Working Example 1 and Working Example 2 were the same in the parameters except for the final heat treatment temperature: diameter (11 μm), additive (Re), amount added (5 wt %), and the number of intermediate recrystallization processes (8 times). Comparison between Working Example 1 and Working Example 2 shows that Working Example 2 with a higher final heat treatment temperature has a higher elongation percentage and a lower tensile strength compared with Working Example 1. Working Example 5 and Working Example 6 were the same in the parameters except for the final heat treatment temperature and showed the same tendency. Working Examples 7 to 9, Working Examples 12 and 13, and Working Examples 14 and 15 were each the same in the parameters except for the final heat treatment temperature, and showed the same tendency. The same tendency is also shown in both a case of a diameter of 11 μm (Working Examples 1 and 2) and a case of a diameter of 35 μm (Working Example 5, etc.).

From these, increasing the final heat treatment temperature can lead to a higher elongation percentage while keeping the tensile strength greater than or equal to 1600 MPa irrespective of a size of the diameter of tungsten wire 10. Conversely, decreasing the final heat treatment temperature can lead to a higher tensile strength while keeping the elongation percentage greater than or equal to 5% irrespective of the size of the diameter of tungsten wire 10.

It should be noted that Comparative Examples 1 and 2 in Table 2 were the same as Working Examples 12 and 13 in Table 1 in the parameters except for the final heat treatment temperature. However, Comparative Examples 1 and 2, in which their final heat treatment temperatures were less than or equal to 1400° C., resulted in elongation percentages that were less than 5%. From this, at least when the diameter is 35 μm, 5 wt % of Re is added, and the intermediate recrystallization process is performed 5 times, it is deemed that the elongation percentage can be brought to be greater than or equal to 5% by performing the manufacture with the final heat treatment temperature being a temperature higher than 1400° C., preferably a temperature greater than or equal to 1500° C.

It should be noted that using Ru as the additive, as in Working Example 11, can keep both a high elongation percentage and a high tensile strength even when the final heat treatment temperature is 1200° C.

### <Number of Intermediate Recrystallization Processes>

Next, the number of intermediate recrystallization processes will be described. Table 1 shows that the elongation percentage tends to increase with an increase in the number of intermediate recrystallization processes. Specifically, when the number of intermediate recrystallization processes is greater than or equal to 5, the elongation percentage can be brought to be greater than or equal to 5%.

Furthermore, Working Example 6 and Working Example 10 in Table 1 were the same in the parameters except for the number of intermediate recrystallization processes: diameter (35 μm), additive (Re), amount added (3 wt %), and final heat treatment temperature (1700° C.). Comparison between Working Example 6 and Working Example 10 shows that Working Example 6 with a larger number of intermediate recrystallization processes had a higher elongation percentage and a lower tensile strength compared with Working Example 10. Conversely, reducing the number of intermediate recrystallization processes can lead to a higher tensile strength while keeping the elongation percentage greater than or equal to 5%.

It should be noted that Comparative Example 4 in Table 2 was the same as Working Examples 6 and 10 in Table 1 in the parameters except for the number of intermediate recrystallization processes. However, in this case, elongation percentages and tensile strengths of Working Examples 6 and 10, in which their numbers of intermediate recrystallization processes were greater than or equal to five, were both higher compared with that of Comparative Example 4, in which its number of intermediate recrystallization processes is three. This point shows that the number of intermediate recrystallization processes being less than or equal to 3 fails to bring the elongation percentage to be greater than or equal to 5%.

Furthermore, Table 1 shows that different diameters require different numbers of intermediate recrystallization processes. Specifically, when the diameter is within a range of greater than or equal to 11 μm and less than or equal to 18 μm, the elongation percentage of tungsten wire 10 was brought to be greater than or equal to 5% when the number of intermediate recrystallization processes is greater than or equal to 8. In contrast, when the diameter is 35 μm, the elongation percentage of tungsten wire 10 was brought to be greater than or equal to 5% when the number of intermediate recrystallization processes is greater than or equal to 5. From this point, it can be determined that obtaining tungsten wire 10 having a smaller diameter only requires a larger number of intermediate recrystallizations than when obtaining tungsten wire 10 having a larger diameter.

It should be noted that the recrystallization process refers to rearrangement of crystals by heat treatment. The recrystallization process accelerates dispersion of a dissolved element such as Re or Ru, thus contributing to an increase in the elongation percentage when the diameter of tungsten wire 10 is reduced. As described above, a dispersity of the alloying element (Re or Ru) in tungsten wire 10 is improved by heating tungsten wire 10 in a form of the recrystallization process in the manufacturing steps. Accordingly, uneven distribution of the alloying element can be suppressed, and thus enhancement in tensile strength and increase in elongation percentage in a thin tungsten wire 10 can both be achieved.

### [Embrittlement]

Subsequently, embrittlement of tungsten wire 10 according to the present embodiment will be described. Hereinafter, embrittlement mainly resulting from hydrogen, that is, hydrogen embrittlement will be described.

The inventors of the present application subjected tungsten wires 10 manufactured based on the manufacturing method mentioned above to hydrogen charging and conducted slow strain rate technique (SSRT) before and after the hydrogen charging.

The hydrogen charging was performed by what is called a cathodic charging method. Specifically, the hydrogen charging was performed in such a manner that target tungsten wire 10 acting as a cathode and platinum acting as an anode were placed in a predetermined electrolyte solution and a current was applied between the anode and the cathode. As the electrolyte solution, a mixed solution of sodium arsenite and sodium chloride was used.

In the slow strain rate technique, target tungsten wire 10 was stretched at a predetermined displacement rate, and an amount of elongation (stroke) and a load at a time when target tungsten wire 10 broke were measured.

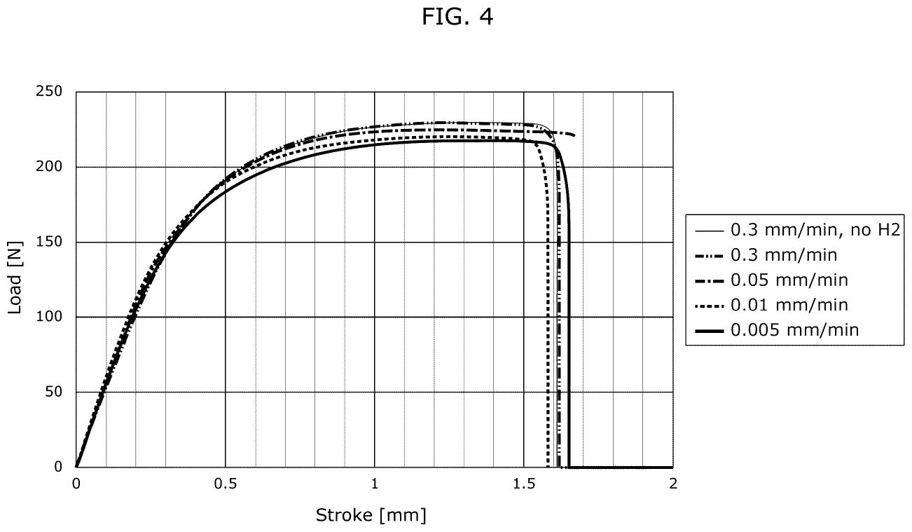

FIG. 4 is a graph illustrating the result of a tensile test on tungsten wire 10 after the hydrogen charging. In FIG. 4, its horizontal axis represents stroke (unit: mm), which is the amount of elongation of tungsten wire 10 being stretched. Its vertical axis represents load (unit: N) that is applied to tungsten wire 10 being stretched.

FIG. 4 shows a graph illustrating changes in load with respect to stroke for each speed of stretching tungsten wire 10 (displacement rate). As illustrated in FIG. 4, at any displacement rate, the load increases with an increase in the stroke, and when a predetermined stroke is reached after the increase in the load has plateaued, the load becomes zero as tungsten wire 10 cannot withstand the load and breaks.

As illustrated in FIG. 4, a maximum value of the load applied to tungsten wire 10 increases with an increase in the displacement rate. For example, FIG. 4 also shows change in load of a tungsten wire not subjected to the hydrogen charging as a comparative example. In the case of a displacement rate of 0.3 mm/min, changes in load of tungsten wires 10 subjected to the hydrogen charging were substantially the same as the change in load of the tungsten wire not subjected to the hydrogen charging. That is, it is found that accurate measurement of change in load (change in tensile strength) due to the hydrogen embrittlement failed at a high displacement rate.

The maximum value of the load applied to tungsten wire 10 decreases with a decrease in the displacement rate. It is inferred that this is because, as the displacement rate decreases, hydrogen charged in tungsten wire 10 tends to gather locally, which facilitates the hydrogen embrittlement to cause breaking.

In a case where the displacement rate is 0.005 mm/min, the maximum value of the load is about 220 N, which is substantially the same as in a case where the displacement rate is 0.01 mm/min. That is, it is found that, at a displacement rate of 0.005 mm/min, reduction in the maximum value of the load is suppressed. For this reason, by conducting the tensile test at a displacement rate of 0.005 mm/min, a decrease in tensile strength due to the hydrogen embrittlement of tungsten wire 10 can be measured accurately.

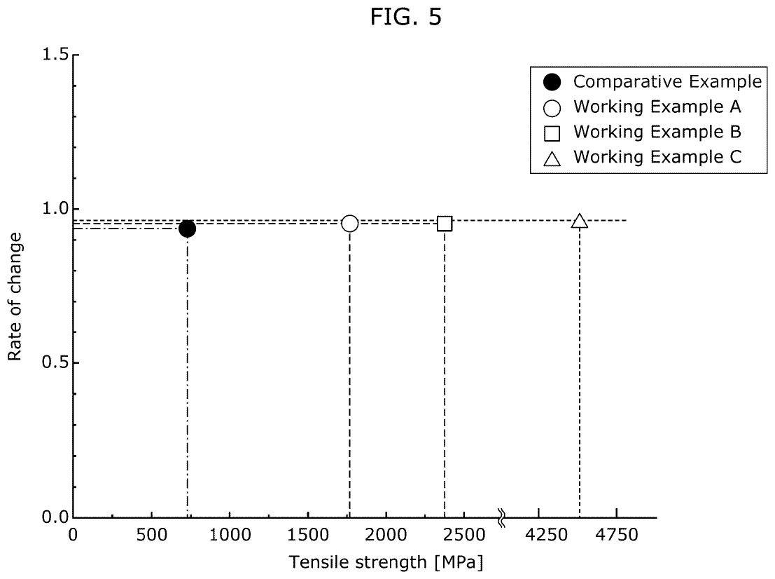

FIG. 5 is a graph illustrating change in tensile strength of tungsten wire 10 before and after the hydrogen charging. In FIG. 5, its horizontal axis represents tensile strength (unit: MPa), and its vertical axis represents a rate of change in tensile strength. The rate of change in tensile strength is a ratio of a tensile strength after the hydrogen charging to a tensile strength before the hydrogen charging. When the rate of change is one, the rate of change indicates that there is no change in the tensile strength after the hydrogen charging. When the rate of change is less than one, the rate of change indicates that there is a decrease in the tensile strength after the hydrogen charging. When the rate of change has a smaller value less than one, the rate of change indicates that an amount of the decrease in the tensile strength after the hydrogen charging is larger.

Furthermore, Table 3 shows changes in tensile strength before and after the hydrogen charging. Table 3 also shows an example of using stainless steel as a comparative example. Plots illustrated in FIG. 5 correspond to the comparative example and Working Examples A to C in Table 3.

TABLE 3

| | | | Tensile | Tensile | Rate of |
|---|---|---|---|---|---|
| | | | strength | strength | change in |
| | | Diam- | before | after | tensile |
| | | eter | charging | charging | strength |
| | Metal | [mm] | [MPa] | [MPa] | [%] |
| Compar- | Stainless | 0.3 | 710 | 660 | 93 |
| ative | steel | | | | |
| Example | (316 L) | | | | |
| Working | Tungsten | 0.35 | 2384 | 2265 | 95 |
| Exampl A | (normal | | | | |
| | strength) | | | | |
| Working | Tungsten | 0.036 | 1777 | 1688 | 95 |
| Example | (high | | | | |
| B | elongation) | | | | |
| Working | Tungsten | 0.036 | 4409 | 4221 | 96 |
| Example | (ultrahigh | | | | |
| C | strength) | | | | |

Table 3 and FIG. 5 show that amounts of the decrease in the tensile strength of tungsten wires before and after the hydrogen charging were small compared with a stainless steel wire. Furthermore, absolute values of the tensile strength of the tungsten wires were high as compared with stainless steel. That is, it is deemed that a tungsten wire can yield high tensile strength and is not likely to cause hydrogen embrittlement compared with a stainless steel wire.

Tungsten is excellent in heat resistant property and does not change in mechanical properties at temperatures up to 900° C. or 1000° C. In particular, in the case of tungsten wire 10 having an elongation percentage greater than or equal to 5%, tungsten wire 10 has been subjected to heat treatment at a temperature greater than or equal to 1200° C. and less than or equal to 1700° C. at a time when tungsten wire 10 is manufactured. For this reason, even when tungsten wire 10 undergoes thermal effect with a temperature less than or equal to 1700° C. prior to or in its use, mechanical properties and a crystal condition of tungsten wire 10 do not change at all. Even in the air or an oxygen atmosphere or even when undergoing thermal effect with a temperature of 200° C., 300° C., or 400° C., the filtering performance of hydrogen-permeable filter 1 can be maintained, with only its surface being slightly oxidized.

### [Bendability of Tungsten Wire]

Subsequently, a bendability of tungsten wire 10 will be described.

As illustrated in FIG. 1, tungsten wire 10 is used as warp yarn and weft yarn of tungsten mesh 2 and is thus required to be capable of withstanding a bending having a curvature greater than or equal to a predetermined curvature. Hence, the inventors of the present application conducted a coiling test to check the bendability of tungsten wire 10. Details and results of the coiling test will be described below.

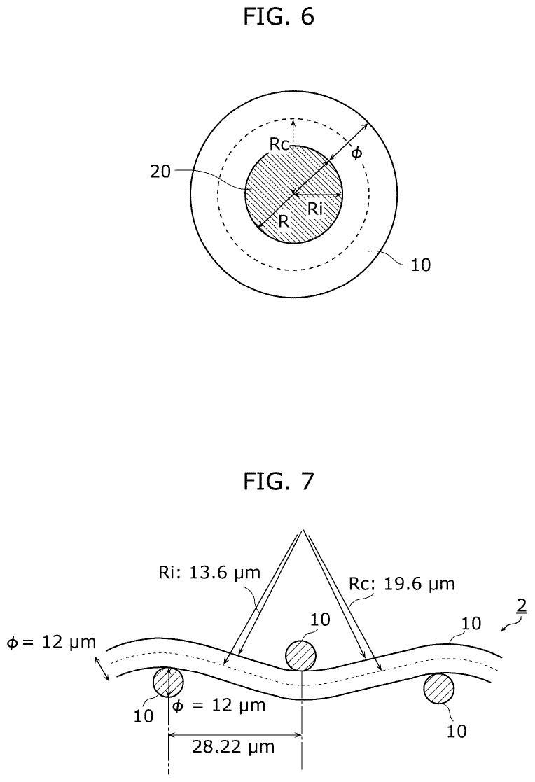

FIG. 6 is a diagram illustrating an outline of the coiling test on tungsten wire 10 according to an embodiment. In the coiling test, tungsten wire 10 was wound around core material 20 that is rod-shaped, has a circular cross-sectional shape, and is uniform in diameter, and whether fracturing or surface delamination of tungsten wire 10 occurs was checked. Diameter R of a cross section of core material 20 and diameter ¢ of tungsten wire 10 used in the coiling test are determined in accordance with, for example, specifications of tungsten mesh 2.

FIG. 7 is a cross-sectional view illustrating tungsten mesh 2 that is woven using tungsten wires 10 according to the present embodiment. Tungsten mesh 2 is a metal mesh that is woven using tungsten wires 10 as warp yarn and weft yarn. Here, a case where, as an example of tungsten mesh 2, plain-weaved tungsten mesh 2 of 900 mesh is manufactured using tungsten wires 10 having a diameter of 12 μm is assumed. Tungsten mesh 2 used as hydrogen-permeable filter 1 has a mesh count of, for example, greater than or equal to 600. Accordingly, the filtering performance of hydrogen-permeable filter 1 can be enhanced. It should be noted that the mesh (mesh count) here means the number of threads that are present within 25.4 mm (1 inch). In this case, a pitch, which is a distance between two adjacent tungsten wires 10, is 28.2 μm (=25.4 mm/900).

In this case, as illustrated in FIG. 7, radius of curvature Rc of tungsten wire 10 is 19.6 μm. It should be noted that radius of curvature Rc is defined based on a central axis of tungsten wire 10 (a broken line in the figure). Furthermore, inner radius of curvature Ri of tungsten wire 10 is 13.6 μm. Inner radius of curvature Ri is defined based on an inner surface of a bend of tungsten wire 10. That is, when neither fracturing nor surface delamination occurs in tungsten wire 10 in a state where radius of curvature Rc is less than or equal to 19.6 μm and inner radius of curvature Ri is less than or equal to 13.6 μm, tungsten wire 10 can be used for the warp yarn and the weft yarn of tungsten mesh 2.

The coiling test was conducted under conditions that exceeded limits for weaving tungsten mesh 2. When neither fracturing (breakage) nor surface delamination occurred in tungsten wire 10 as a result of the coiling test conducted under the conditions exceeding the limits for the weaving, it is possible to stably manufacture tungsten mesh 2 using tungsten wire 10 used in the test.

For example, a condition in which tungsten wires 10 having a diameter of 12 μm come into contact with each other is a case of 1222 mesh. That is, it is not possible to manufacture tungsten mesh 2 having a mesh count greater than or equal to 1222 mesh. As a condition for the coiling test, tungsten mesh 2 of 1324 mesh including 12-μm tungsten wire 10 is assumed.

It should be noted that breaking of tungsten wire 10 is caused by strain in the material constituting tungsten wire 10, and thus tungsten wire 10 of a different diameter can be used for study. For example, in terms of 35-μm tungsten wire 10, the condition of 12-μm 1324 mesh converts to 454 mesh (=1324 mesh×12 μm/35 μm). Under this condition, radius of curvature Rc is 31 μm, and inner radius of curvature Ri is 13.5 μm.

In the coiling test, the inventors of the present application used core material 20 having diameter R=27 μm and tungsten wire 10 having diameter ϕ=35 μm. Tungsten wire 10 wound around core material 20 has inner radius of curvature Ri being 13.5 μm (=R/2) and radius of curvature Rc being 31.0 μm (=Ri+ϕ/2). Therefore, when neither fracturing nor surface delamination occurred in the coiling test under this condition, this means that it is possible to manufacture tungsten mesh 2 of 900 mesh using 12-μm tungsten wire 10.

Results of the coiling test conducted on Comparative Examples 9 and 10, and Working Example 16 are shown in Table 4 below. It should be noted that, in all of Comparative Working Examples 9 and 10, and Working Example 16, their diameters were 35 μm, their alloying elements being the additives were Re, and their amounts added were 5 wt %. Furthermore, their numbers of intermediate recrystallization processes were all 6.

TABLE 4

| | | | Final heat | | |
|---|---|---|---|---|---|
| | | | treatment | | |
| | Elongation | Tensile | temper- | | |
| | percentage | strength | ature | | Surface |
| No. | [%] | [MPa] | [° C.] | Fracturing | delamination |
| Comparative | 3 | 2160 | 1200 | Fractured | — |
| Example 9 | | | | | |
| Comparative | 4 | 2130 | 1300 | Not | Occurred |
| Example 10 | | | | fractured | slightly |
| Working | 5 | 2100 | 1400 | Fractured | Not observed |
| Example 16 | | | | | |

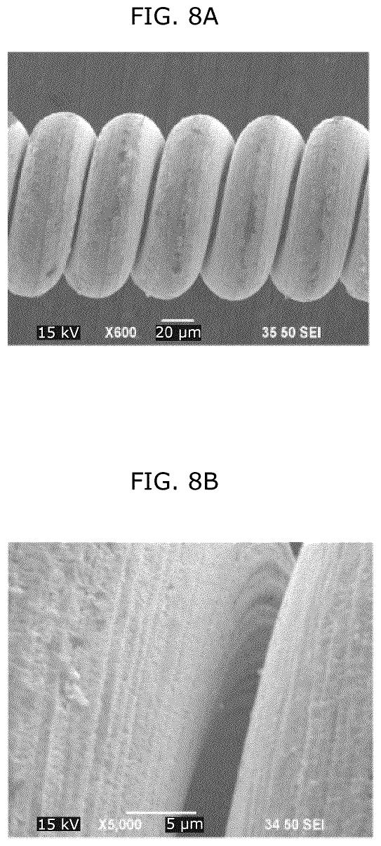

FIG. 8A is a diagram illustrating an external appearance of a tungsten wire according to Working Example 16 subjected to the coiling test. FIG. 8B is a diagram illustrating a part of FIG. 8A under magnification. As illustrated in FIG. 8A and FIG. 8B, in Working Example 16, neither fracturing nor surface delamination occurred in tungsten wire 10.

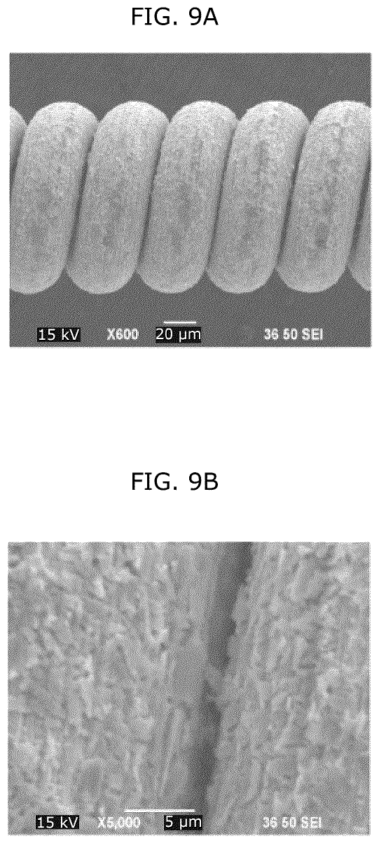

FIG. 9A is a diagram illustrating an external appearance of a tungsten wire according to Comparative Example 10 subjected to the coiling test. FIG. 9B is a diagram illustrating a part of FIG. 9A under magnification. As illustrated in FIG. 9A and FIG. 9B, in Comparative Working Example 10, although no fracturing occurred in the tungsten wire, a surface delamination occurred slightly. Therefore, although tungsten mesh 2 can be manufactured even when the elongation percentage is 4%, the elongation percentage is desirably greater than or equal to 5% for manufacturing tungsten mesh 2 of higher quality.

It should be noted that the diameter of tungsten wire 10 and the pitch of the mesh is not limited to the above examples.

### Advantageous Effects, Etc.

In a conventional hydrogen-permeable filter, the metal mesh is made up of a plurality of stainless steel wires, and thus bending stress is imparted on each of the plurality of stainless steel wires. When the hydrogen-permeable filter is exposed to hydrogen in this state, hydrogen atoms collect at portions where the bending stress are imparted, causing embrittlement, which finally brings about breaking. That is, a tear of the metal mesh occurs, and thus the filtering performance deteriorates. Conventionally, four or more metal meshes are provided in a layered manner so that, even if a tear occurs, deterioration of filtering performance is suppressed. Furthermore, embrittlement may result from heat.

In contrast, hydrogen-permeable filter 1 according to the present embodiment includes tungsten mesh 2 including a plurality of tungsten wires 10 that are woven.

Accordingly, since the embrittlement does not occur easily in tungsten wires 10 compared with stainless steel wires, it is possible to provide hydrogen-permeable filter 1 in which embrittlement does not occur easily. For example, embrittlement resulting from hydrogen or heat does not occur easily in tungsten wire 10 compared with a stainless steel wire. For this reason, it is possible to provide hydrogen-permeable filter 1 that is excellent in durability. Since a tear of tungsten mesh 2 does not occur easily, the number of layered tungsten meshes 2 may be small, and only one tungsten mesh 2 can be used to provide hydrogen-permeable filter 1 having high filtering performance.

Furthermore, for example, the plurality of tungsten wires 10 each have an elongation percentage greater than or equal to 5%.

Accordingly, by using tungsten wire 10 that has a high elongation percentage, complex weaving processing or knitting processing can be performed. Since fine tungsten mesh 2 having small openings can be realized, the filtering performance of hydrogen-permeable filter 1 can be enhanced.

Furthermore, for example, tungsten mesh 2 has a mesh count greater than or equal to 600.

Accordingly, since fine tungsten mesh 2 having small openings can be realized, the filtering performance of hydrogen-permeable filter 1 can be enhanced.

Furthermore, for example, the plurality of tungsten wires 10 each have a tensile strength greater than or equal to 1600 MPa.

Accordingly, the occurrence of breaking during manufacturing of tungsten mesh 2 and during use of hydrogen-permeable filter 1 can be suppressed. For this reason, hydrogen-permeable filter 1 having high reliability can be realized.

Furthermore, for example, the plurality of tungsten wires 10 may each have a tensile strength greater than or equal to 2400 MPa.

Accordingly, hydrogen-permeable filter 1 having higher reliability can be realized.

Furthermore, for example, the plurality of tungsten wires 10 may each have a tensile strength greater than or equal to 4800 MPa.

Accordingly, hydrogen-permeable filter 1 having even higher reliability can be realized.

Furthermore, for example, the plurality of tungsten wires 10 each have a diameter less than or equal to 40 μm.

Accordingly, since fine tungsten mesh 2 having small openings can be realized, the filtering performance of hydrogen-permeable filter 1 can be enhanced.

Furthermore, for example, a weave pattern of tungsten mesh 2 is Dutch weave.

Accordingly, since fine tungsten mesh 2 having small openings can be realized, the filtering performance of hydrogen-permeable filter 1 can be enhanced.

Furthermore, for example, hydrogen-permeable filter 1 is used within a range in which hydrogen pressure is less than or equal to 135 MPa. Furthermore, hydrogen-permeable filter 1 may be used within a range in which hydrogen pressure is less than or equal to 110 MPa. Alternatively, hydrogen-permeable filter 1 may be used within a range in which hydrogen pressure is less than or equal to 70 MPa.

Accordingly, hydrogen-permeable filter 1 can be sufficiently used in various applications such as in a testing environment, a hydrogen station, or an automobile equipped with a fuel cell or hydrogen fuel engine.

### Others

Although the hydrogen-permeable filter according to the present invention has been described above based on the forgoing embodiments, and so on, the present invention is not limited to the foregoing embodiments.

For example, the weave pattern of tungsten mesh 2 may be plain weave, twill weave, or satin weave. Tungsten mesh 2 may be manufactured by performing knitting processing such as stockinette stitch with a predetermined gauge using a plurality of tungsten wires 10 as knitting yarns.

Furthermore, for example, the present disclosure may be implemented in a form of a fuel cell including hydrogen-permeable filter 1, an automobile including the fuel cell, or the like. It should be noted that hydrogen-permeable filter 1 is not limited to being used in a fuel cell, and hydrogen-permeable filter 1 can be used in various environments in which hydrogen is used.

For example, hydrogen-permeable filter 1 can be used in a filter of a hydrogen liquefier that liquefies hydrogen in a hydrogen station. A compressor of a hydrogen liquefier can have a temperature of about 300° C. Tungsten mesh 2, which is excellent in heat resistant property, can be used as a heat-resistant filter.

Furthermore, tungsten mesh 2 can be used in other applications in addition to hydrogen-permeable filter 1. As mentioned above, according to the present disclosure, by using tungsten wires 10, which has a high elongation percentage, fine tungsten mesh 2 having small openings can be provided. Thus, tungsten mesh 2 can be used in a filter that is required to have a high filter rating, a screen mesh used for printing, and the like. In addition, tungsten mesh 2 can be used as a heat-resistant filter, a mesh heater, a functional filter that cuts off an electromagnetic wave and the like, rather than hydrogen-permeable filter 1.

Aside from the above, forms obtained by various modifications to respective embodiments that can be conceived by those skilled in the art, as well as forms realized by combining constituent elements in the respective embodiments, without materially departing from the spirit of the present disclosure are included in the present invention.

### REFERENCE SIGNS LIST

1 hydrogen-permeable filter
2 tungsten mesh
10 tungsten wire

1. A hydrogen-permeable filter comprising:
a tungsten mesh including a plurality of tungsten wires that are woven.

2. The hydrogen-permeable filter according to claim 1, wherein
the plurality of tungsten wires each have an elongation percentage greater than or equal to 5%.

3. The hydrogen-permeable filter according to claim 2, wherein
the tungsten mesh has a mesh count greater than or equal to 600.

4. The hydrogen-permeable filter according to claim 1, wherein
the plurality of tungsten wires each have a tensile strength greater than or equal to 1600 MPa.

5. The hydrogen-permeable filter according to claim 1, wherein
the plurality of tungsten wires each have a tensile strength greater than or equal to 2400 MPa.

6. The hydrogen-permeable filter according to claim 1, wherein
the plurality of tungsten wires each have a tensile strength greater than or equal to 4800 MPa.

7. The hydrogen-permeable filter according to claim 1, wherein
the plurality of tungsten wires each have a diameter less than or equal to 40 μm.

8. The hydrogen-permeable filter according to claim 1, wherein
a weave pattern of the tungsten mesh is Dutch weave.

9. The hydrogen-permeable filter according to claim 1, wherein
the hydrogen-permeable filter is used within a range in which hydrogen pressure is less than or equal to 135 MPa.
